(19) United States
(12) Patent Application Publication
(10) Pub. No.: US 2018/0075670 A1
(43) Pub. Date: Mar. 15, 2018

(54) DEDICATED SHORT-RANGE COMMUNICATION VEHICLE MANAGEMENT APPARATUSES, SYSTEMS AND METHODS

(71) Applicant: Laird Technologies, Inc., Earth City, MO (US)

(72) Inventors: Balachander Rajakondala, Holly, MI (US); Raghavendar Changalvala, Troy, MI (US); Panamalai Gopalakrishnan Gururaj, Holly, MI (US)

(21) Appl. No.: 15/293,497

(22) Filed: Oct. 14, 2016

Related U.S. Application Data
(60) Provisional application No. 62/385,547, filed on Sep. 9, 2016.

(51) Int. Cl. G07C 5/00; H04W 4/00; H04L 29/12; H04L 29/08; G01S 19/42; G06F 9/445

(52) U.S. Cl. CPC G07C 5/008; H04W 4/008; H04L 61/6022; H04W 84/12; G01S 19/42; G06F 8/65; H04L 67/12

(57) ABSTRACT

Exemplary embodiments are provided of dedicated short-range communication (DSRC) vehicle management apparatuses, systems and methods. In an exemplary embodiment, DSRC apparatus for a vehicle generally includes a receiver (e.g., a global positioning system (GPS) receiver, etc.) configured to determine a location of the vehicle, a vehicle bus interface coupled to a vehicle bus of the vehicle to obtain diagnostics of the vehicle, and a DSRC wireless interface configured to communicate wirelessly with a vehicle management server. The DSRC wireless interface is configured to obtain vehicle information from the receiver and/or the vehicle bus interface and transmit the obtained vehicle information to the vehicle management server. Also disclosed are exemplary DSRC vehicle management systems including a vehicle management server and multiple DSRC apparatuses coupled to different vehicles, and DSRC vehicle management methods.

### CROSS-REFERENCE TO RELATED APPLICATION

This application claims the benefit of and priority to U.S. Provisional Application No. 62/385,547 filed Sep. 9, 2016. The entire disclosure of the above application is incorporated herein by reference.

### FIELD

The present disclosure generally relates to dedicated short-range (DSRC) vehicle management apparatuses, systems and methods.

### BACKGROUND

This section provides background information related to the present disclosure which is not necessarily prior art.

At automotive dealerships, vehicle location can be stored to dealers to locate vehicles on the dealership lot. At automotive service centers, vehicle diagnostic information may be used by technicians to recommend maintenance for a vehicle. Electronic control units (ECUs) of vehicles can include firmware that may need to be upgraded from time to time. Dedicated short-range communication is a protocol allowing vehicles to talk to one another (e.g., V2V), to talk to infrastructure (e.g., V2I), or broadly to talk to any other device adapted to communicate via a DSRC wireless interface (e.g., V2X).

### DRAWINGS

The drawings described herein are for illustrative purposes only of selected embodiments and not all possible implementations, and are not intended to limit the scope of the present disclosure.

FIG. 1 is a diagram of an example DSRC apparatus according to an exemplary embodiment;

FIG. 2 is a diagram of an example vehicle management server according to another exemplary embodiment;

FIG. 3 is a diagram of an example dealership vehicle management system including the DSRC apparatus of FIG. 1 and the vehicle management server of FIG. 2, according to another exemplary embodiment; and

FIG. 4 is a diagram of an example service center vehicle management system including the DSRC apparatus of FIG. 1 and the vehicle management server of FIG. 2, according to another exemplary embodiment.

### DETAILED DESCRIPTION

Example embodiments will now be described more fully with reference to the accompanying drawings.

The inventors herein have recognized that at automobile vehicle dealerships, vehicle lots can be managed using a manual entry process where vehicle parking position is manually entered into a vehicle lot management database. When a dealer wants to locate a particular vehicle, the dealer can go through the most recent database, which might not be accurate based on the fact that vehicles are moved constantly for customer test drives, etc. Some dealers may install telematics, tracking, etc. devices in the vehicles to get real-time vehicle location updates. These devices can be expensive as they may need cellular network, WiFi, BLUETOOTH, etc. interfaces, and may need to be purchased and installed separately by the dealer. These devices could become redundant once the cars get equipped with DSRC infrastructure.

The inventors have developed a vehicle management system where fleet tracking in a controlled area can be achieved using DSRC. For example, a DSRC apparatus can update a vehicle management server (e.g., vehicle database, etc.) with its location, its most recent position before ignition turn-off, etc. Using DSRC capability in a vehicle, a dealer can implement a vehicle lot management system using a V2X infrastructure at the dealership.

For example, when vehicles are brought onto the lot, the DSRC system can be used to store the location of the vehicle in a database. A vehicle can be identified based on a DSRC media access control (MAC) address. Additional status data including fuel level, battery charge status, etc., can also be captured over the DSRC interface. Data collected over DSRC interface can be tied to a vehicle identification number (VIN), such that the dealer can manage data of the vehicle, including a VIN of the vehicle, a last known position of the vehicle, a type of the vehicle, etc.

Example systems described herein may provide one or more advantages, including but not limited to, simplified vehicle lot management, reduced cost (e.g., fixed cost associated with the vehicle management system implementation and no additional cost to scale to larger lots), ease of synchronization with other dealerships, ability to use aftermarket light-weight DSRC products to support vehicles that do not have existing DSRC infrastructure, etc.

The inventors herein have also recognized that in the automotive industry, firmware of an on-board microcontroller, electronic control unit, etc. can be upgraded over a vehicle bus. Vehicle service centers can use an on-board diagnostics (OBD) interface, vehicle bus interface, etc. to communicate with the electronic control unit (ECU).

The inventors have developed a system where using a DSRC interface, which may not include physically connecting to the vehicle, service centers can upgrade the firmware of an ECU in the vehicle. This approach may be beneficial during mass recalls that require firmware upgrades, etc. Technicians can flash multiple vehicles substantially simultaneously, without having to be physically connected to the vehicles. This approach could work in a controlled environment, including but not limited to dealerships, service centers, etc.

Example DSRC based telematics systems may include a global positioning system (GPS) receiver, a vehicle bus interface, a DSRC radio, a processor, memory (e.g., random access memory (RAM), flash memory, etc.), etc. Using the DSRC radio as an access link, a telematics device can act as a gateway to a controller area network (CAN) bus of the vehicle. The telematics device can route data between the vehicle CAN and the DSRC radio (e.g., an 802.11p wireless interface, etc.).

The inventors have recognized that some firmware updates are performed over wired interfaces like CAN, vehicle bus, universal serial bus (USB), universal asynchronous receiver/transmitter (UART), Ethernet, etc., some firmware updates are performed over wireless interfaces like WiFi, BLUETOOTH, cellular modems, etc. The inventors have developed a system for providing firmware upgrades over the DSRC's 802.11p wireless medium.

Before beginning the firmware upgrade, the vehicle and service center can participate in an authentication and authorization session over the DSRC link for mutual verification and validation. Once verified, the service center can check with the original equipment manufacturer (OEM) to verify if there is any firmware upgrade needed for any ECU. If the service center gets a notice from the OEM that a firmware update is needed on an ECU, the service center could initiate a firmware update on that particular ECU via the DSRC link. A DSRC telematics device can also be used to update the firmware of the telematics device over the DSRC wireless interface. This approach may allow for reducing support time for executing firmware updates, providing firmware updates automation with reduced (or without) human intervention, etc.

The inventors herein have also recognized that when a vehicle enters a service center, there can be a manual intervention in collecting vehicle data such as service records, diagnostic information, etc., where a technician would insert an on-board diagnostics (OBD) BLUETOOTH, WiFi, etc. dongle into the vehicle's diagnostic port, which may collect and transmit diagnostic data to a service desk. The OBD dongles may have increased cost, and the process of manually collecting data can increase service time and delays in the service line.

The inventors have developed a system where a service center can collect vehicle data remotely (e.g., as soon as the vehicle enters the service center, etc.) with reduced manual intervention (or no manual intervention). A technician could be ready with vehicle information, service records, etc. when the vehicle owner approaches the service desk, which may save time for the technician, the vehicle owner, etc.

This approach can be achieved using DSRC technology. The vehicle's on-board unit (OBU) can have access to vehicle data over, for example, J1939 (CAN), and can collect vehicle diagnostic information by running queries, etc. A remote server (e.g., road side unit (RSU), etc.) can be placed in dealerships, service centers, etc. to collect vehicle diagnostic information and relay it to the server along with other relevant data once the vehicle enters the service center's premises.

In some embodiments, the system may implement security measures, including but not limited to an authentication mechanism on the top of the DSRC stack, to prevent unauthorized collection of data by the service centers, etc. The system may use a vehicle bus and DSRC interface of the vehicle where a service center's RSU would detect the proximity of an approaching vehicle to the server. The server may send a request to collect diagnostic information from the vehicle over DSRC, which the vehicle could accept (e.g., after an authentication routine, etc.). The service center could collect vehicle data over DSRC and upload it to the server. A technician could then be ready with information by the time vehicle owner walks to the service center desk. The system may provide faster service, shorter wait times, lower cost, simpler interfaces, etc.

In some embodiments, dealerships may obtain vehicle location from DSRC messages of vehicle DSRC units (e.g., V2X units, etc.). The location information of the vehicle (e.g., GPS, global navigation satellite system (GNSS), etc. coordinates) is received from the GPS, GNSS, etc. receiver of the V2X system installed on the vehicle, and this information is sent to a dealership V2X device over DSRC. The V2X system may send a unique identifier with the location information. The unique identifier may be known by the dealer during initial provisioning of the vehicle and the information may be saved in the database of a vehicle management server. In service centers, the vehicle V2X system may have the ability to talk to vehicle ECUs for querying ECU diagnostics.

The inventors have recognized dealers may use standalone devices or barcodes on a vehicle to manage the vehicles in their lot. These systems can be expensive to maintain by the dealer. The inventors have developed DSRC based systems to help dealers, which may not require any extra hardware cost to the dealers as future vehicle may already have V2X systems built in the vehicles. The OEMs may install example systems described herein in vehicles during manufacture. This may assist dealers in managing new devices in their lot, help them diagnose problems in vehicles on their lot, etc. For example, before delivering a vehicle to the lot some vehicles may be parked for longer durations, such that the battery charge on the vehicle may be low. Recharging the battery or jump starting the vehicle can be time consuming. With some example systems proposed herein, a dealer can periodically run diagnostics on multiple vehicles in the inventory and can identify and fix vehicle problems sooner.

In some embodiments, an OEM may add example systems described herein to the vehicle during manufacture, thereby creating a value added feature for lot management of the OEM, for lot management of dealers, etc., which could benefit OEMs and their dealers. Example systems could be implemented as aftermarket products where dealers need to install the systems on the vehicles. If DSRC systems are already installed on the vehicle, a software application may be downloaded to the vehicle using OEM interfaces, etc.

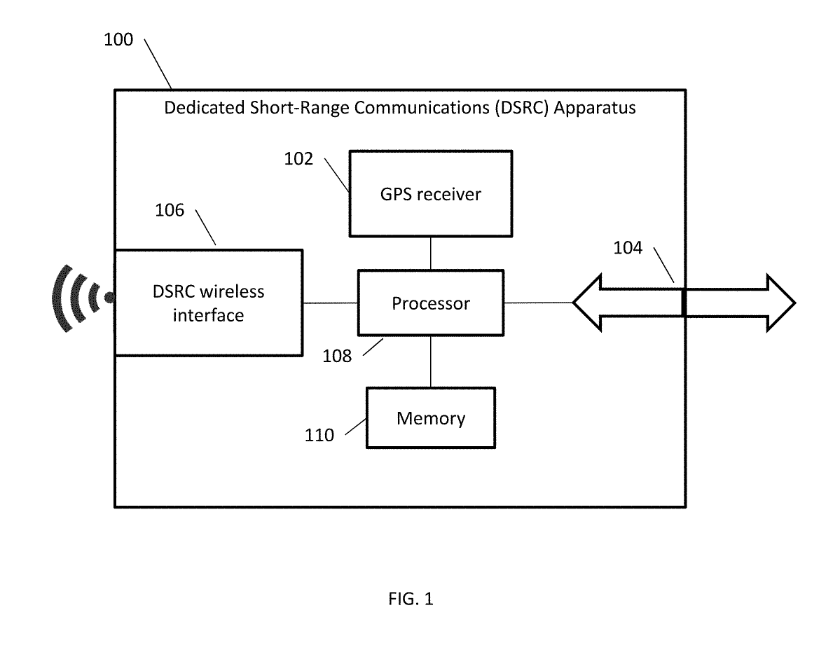

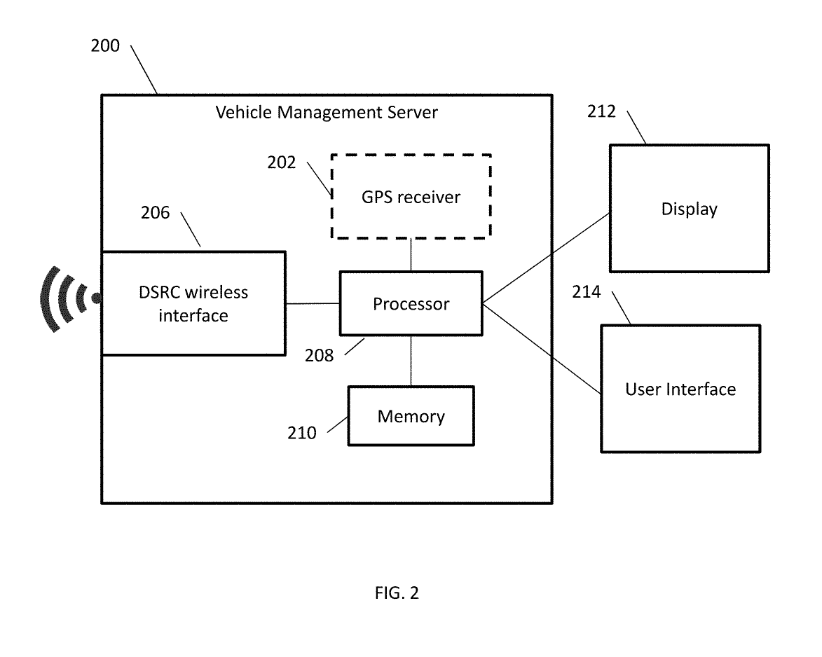

Exemplary embodiments are provided of DSRC vehicle management systems. FIGS. 1 and 2 illustrate exemplary embodiments of a dedicated short-range communications (DSRC) apparatus 100 for a vehicle, and a vehicle management server 200.

As shown in FIG. 1, the DSRC apparatus 100 includes a global positioning system (GPS) receiver 102, a vehicle bus interface 104, and a DSRC wireless interface 106. The GPS receiver 102 is configured to determine a location of the vehicle. The vehicle bus interface 104 is coupled to a vehicle bus of the vehicle to obtain diagnostics of the vehicle. The DSRC wireless interface 106 is configured to communicate wirelessly with a vehicle management server 200 (e.g., the vehicle management server 200 may be remote from, physically separate from, etc. the DSRC apparatus 100). The DSRC apparatus 100 may include a processor 108 and memory 110.

As shown in FIG. 2, the vehicle management server 200 includes a DSRC wireless interface 206, which may be configured to communicate wirelessly with the DSRC wireless interface 106 of the DSRC apparatus 100 of FIG. 1. For example, the vehicle management server 200 may send, receive, etc. vehicle information to and/or from the DSRC apparatus 100 via the DSRC wireless interface 206. The vehicle management server 200 may include an optional GPS receiver 202, a processor 208, memory 210, etc. For example, the processor 208 may be coupled to a display 212 for displaying information to a user, the processor 208 may be coupled to a user interface 214 for receiving information from a user, etc.

The display 212 can be any suitable display, including but not limited to a computer screen, phone screen, tablet screen, etc. The user interface 214 can be any suitable interface, including but not limited to a keyboard, mouse, touchscreen, etc.

The vehicle management server 200 can be any suitable server, including but not limited to a vehicle management server of a vehicle dealership, a vehicle service center, an original equipment manufacturer (OEM), etc. For example, the vehicle management server 200 may include one or more computers, servers, tablet devices, smartphones, other computing devices, etc. by which vehicle operators can manage vehicles. The vehicle management server 200 can manage vehicles on a dealership lot by storing information about vehicle location, vehicle type, vehicle status, etc. The vehicle management server 200 can manage vehicles of a service center by storing vehicle service records, vehicle type information, vehicle status information, etc.

Referring again to FIG. 1, the DSRC wireless interface 106 is configured to obtain vehicle information from the GPS receiver 102 and/or the vehicle bus interface 104 and transmit the obtained vehicle information to the vehicle management server 200. For example, after the GPS receiver 102 determines a location of the vehicle, the DSRC wireless interface 106 may obtain the vehicle location from the GPS receiver 102 and transmit the vehicle location to the vehicle management server 200. Other embodiments may include any suitable global navigation satellite system (GNSS) receiver(s) (e.g., global positioning system (GPS), European Galileo system, the Russian GLONASS, the Chinese Beidou navigation system, the Indian IRNSS, etc.).

The vehicle management server 200 may then store the received location information of the vehicle (e.g., by updating a vehicle location database, etc.) such that the vehicle management server can track vehicle location. For example, a dealership may keep records of locations of vehicles on the dealership lot in the vehicle management server 200, and the DSRC apparatus 100 may provide a convenient way for the dealership to keep updated, reliable information about vehicle location.

In some embodiments, after the vehicle bus interface 104 obtains vehicle diagnostics from a vehicle bus of the vehicle, the DSRC wireless interface 106 may transmit the vehicle diagnostics to the vehicle management server 200. For example, the DSRC apparatus 100 may transmit any suitable vehicle diagnostic information to the vehicle management server 200, including but not limited to a fuel level of the vehicle, a battery charge status of the vehicle, etc. This can allow the vehicle management server 200 to store diagnostics of the vehicle, to provide alerts when vehicle diagnostics indicate a problem, etc. Accordingly, a dealership, service center, etc. may be able to diagnose and fix problems sooner, etc.

As should be apparent, the DSRC wireless interface 106 may include any suitable interface capable of wireless dedicated short-range communications. For example, the DSRC wireless interface 106 may be configured to communicate wirelessly at a frequency of about 5.9 Gigahertz (GHz). The DSRC wireless interface 106 may be configured to communicate wirelessly via the IEEE 802.11p wireless communication protocol. The DSRC wireless interface 106 may be configured to communicate via vehicle to vehicle (V2V) protocols, vehicle to infrastructure (V2I) protocols, vehicle to any (V2X) protocols, etc. The DSRC wireless interface 106 can include any suitable antenna element(s), radio(s), etc. to facilitate wireless communication.

In some embodiments, the DSRC wireless interface may be configured to transmit a DSRC media access control (MAC) address of the DSRC apparatus 100 to the vehicle management server 200. This can allow the vehicle management server 200 to identify the vehicle based on the received MAC address from the DSRC wireless interface 106. For example, each vehicle can include a DSRC apparatus 100 having a unique MAC address. When the DSRC apparatus 100 contacts the vehicle management server 200, the MAC address can be provided so that the vehicle management server 200 can associate the MAC address with the vehicle. The vehicle management server 200 can then store the associated MAC addresses and corresponding vehicles so that the vehicle management server 200 can track, identify, etc. vehicles based on MAC addresses, can automatically associate received location information, diagnostic information, etc. with a vehicle based on the received MAC address, etc.

As should be apparent, the vehicle bus interface 104 may include any suitable bus interface capable of obtaining diagnostic information from the vehicle. For example, the vehicle bus interface 104 may include a bus interface adapted to connect to an on-board diagnostics (e.g., OBD, OBD-II, etc.) port of the vehicle, a controller area network (CAN) bus of the vehicle, etc. The vehicle bus interface 104 may obtain any suitable vehicle diagnostic information from the vehicle bus, the electronic control unit (ECU) of the vehicle, etc.

The DSRC wireless interface 106 may be configured to obtain firmware information from the electronic control unit (ECU) of the vehicle (e.g., via a vehicle bus, etc.), and to transmit the obtained firmware information to the vehicle management server 200. This can allow the vehicle management server 200 to determine whether a firmware update is needed for the ECU of the vehicle. For example, the vehicle management server 200 may periodically receive firmware updates from an original equipment manufacturer (OEM) of the vehicle, etc. The vehicle management server 200 can compare the firmware version obtained from the DSRC apparatus 100 to the latest firmware version from the manufacturer, to check whether an update is needed. As another example, the vehicle management server 200 may send the obtained firmware information, version, etc. to a manufacturer, compare the version to a most recent version number, etc. to determine whether an update is needed.

Upon determining that a firmware update is needed, the vehicle management server 200 may transmit the firmware upgrade data to the DSRC apparatus 100, via the DSRC wireless interface 106. For example, the vehicle management server 200 may have a latest firmware version stored on the server, may obtain a firmware update from the manufacturer, etc. The DSRC apparatus 100 can be configured to transmit the received firmware upgrade data to the ECU of the vehicle via the vehicle bus interface 104. This may allow the ECU to update its firmware versions.

In some embodiments, the DSRC apparatus 100 may receive firmware upgrade data for the DSRC apparatus from the vehicle management server 200. For example, the vehicle management server 200 may transmit firmware upgrade data to the DSRC apparatus 100 when the DSRC apparatus firmware is out of date. This may allow the DSRC apparatus 100 to upgrade its own firmware to the latest version via the DSRC wireless interface 106.

As should be apparent, the DSRC apparatus 100 may include any apparatus suitable for integration with a vehicle and capable of transmitting information via a DSRC wireless interface. For example, the DSRC apparatus 100 may be installed to, mounted to, coupled to, manufactured with, integrated with, etc. the vehicle. In some embodiments, the DSRC apparatus 100 may be integrated with the vehicle during manufacture by an original equipment manufacturer (OEM). In some embodiments, the DSRC apparatus 100 may be an aftermarket apparatus that is coupled to the vehicle.

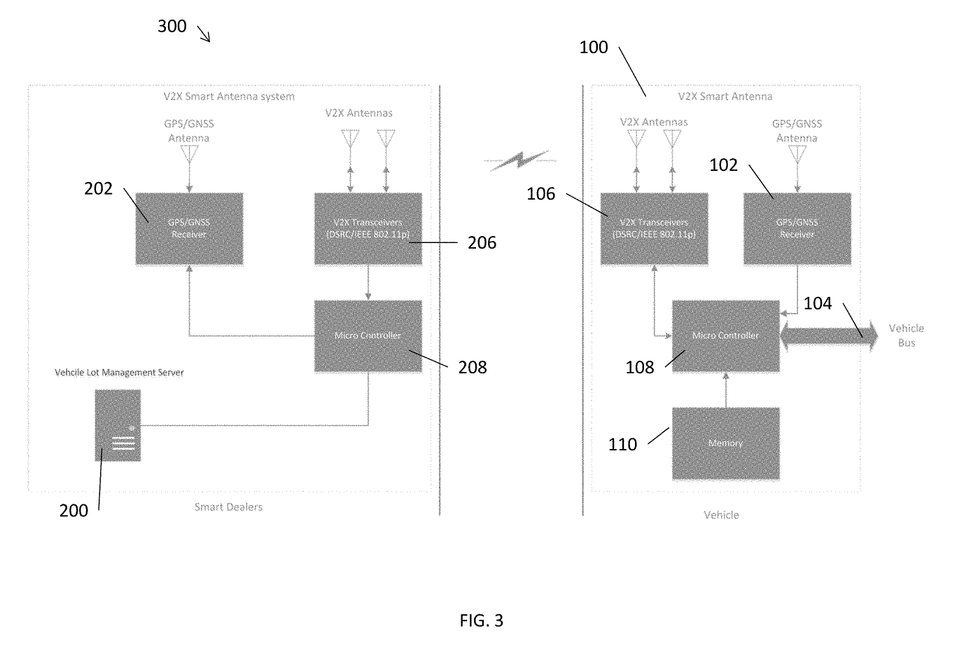

FIG. 3 illustrates an example vehicle management system 300, according to another example embodiment of the present disclosure. The vehicle management system 300 includes a DSRC apparatus 100 similar to FIG. 1, and a vehicle management server 200 (e.g., a smart dealer) similar to FIG. 2.

Although FIG. 3 illustrates only one DSRC apparatus 100, it should be apparent that the system 300 can include multiple DSRC apparatuses, with each DSRC apparatus coupled to a different vehicle. The vehicle management server 200 can be configured to receive vehicle information from the multiple DSRC apparatuses. For example, the vehicle management server can receive vehicle location information, vehicle diagnostic information, etc. from the DSRC wireless interfaces 106 of the DSRC apparatuses 100, as described above.

The vehicle management server 200 may be configured to receive a MAC address from each DSRC apparatus 100, and to synchronize each received DSRC MAC address with a vehicle identification number (VIN) of the vehicle associated with the DSRC MAC address to determine which vehicle corresponds to each DSRC MAC address. As described above, this may allow the vehicle management server 200 to store and track each vehicle based on a VIN associated with each DSRC MAC address.

The vehicle management server 200 may be configured to receive firmware update information from a DSRC apparatus 100, and determine whether a firmware update is needed based on the firmware information received from the DSRC apparatus 100. When a firmware update is needed, the vehicle management server can transmit firmware update information to the DSRC apparatus 100 via the DSRC wireless interface 206, thereby allowing the DSRC apparatus 100 to update the firmware of the ECU of the vehicle.

In some embodiments, the vehicle management server 200 may be configured to detect an approaching vehicle having one a DSRC apparatus 100. For example, the vehicle management server 200 may include a proximity detector, a DSRC wireless communication detector, etc. Upon detecting an approaching vehicle, the vehicle management server 200 may transmit a request for vehicle diagnostic information from the DSRC apparatus 100. The request man may include any suitable security information, authorization information, authentication information, etc. to inhibit improper access to the vehicle diagnostic information.

The vehicle management server 200 may be configured to obtain the diagnostic information of the vehicle via wireless transmission from the DSRC wireless interface 206 of the vehicle management server 200. The vehicle management server 200 may then display the obtained vehicle diagnostic information on a display, thereby allowing a technician to view the obtained diagnostic information. In some embodiments, the vehicle management server may also display previous service records for the identified vehicle that are stored in the vehicle management server 200 (e.g., based on previous service performed on the vehicle at the service center, etc.).

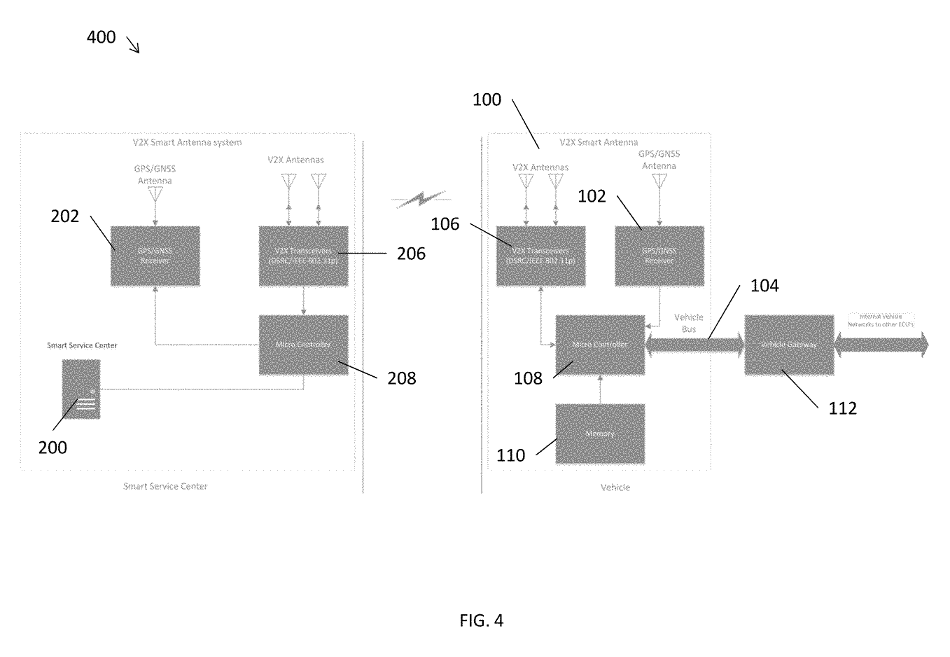

FIG. 4 illustrates another example vehicle management system 400 that is similar to the system 300 of FIG. 3, but the vehicle management server 200 is a smart service center. Although only one DSRC apparatus 100 is illustrated, it should be apparent the multiple DSRC apparatuses may be included in the vehicle management system 400 and configured for wireless DSRC communication with the vehicle management server 200.

The DSRC apparatus 100 of FIG. 4 includes a vehicle bus 400 that is coupled to a vehicle gateway 112 of a vehicle. The vehicle gateway 112 may provide access to internal vehicle networks, including ECU(s), etc.

According to another example embodiment of the present disclosure, a method of managing a vehicle using a dedicated short-range communications (DSRC) apparatus is disclosed. The DSRC apparatus is coupled to the vehicle and includes a global positioning system (GPS) receiver for determining a location of the vehicle, a vehicle bus interface coupled to a vehicle bus of the vehicle to obtain diagnostics of the vehicle, and a DSRC wireless interface configured to wirelessly transmit vehicle information to a vehicle management server. The method includes obtaining vehicle information via the GPS receiver and/or the vehicle bus interface, and transmitting the obtained vehicle information to the vehicle management server via the DSRC wireless interface.

In some embodiments, the method may include transmitting firmware update data from the vehicle management server to the DSRC wireless interface, and providing the firmware update data to an electronic control unit (ECU) of the vehicle via the vehicle bus interface, thereby allowing the ECU to upgrade its firmware.

The method may include detecting an approach of the vehicle having the DSRC apparatus, transmitting a request for vehicle diagnostic information from the vehicle management server to the DSRC wireless interface, transmitting diagnostic information of the vehicle from the DSRC wireless interface to the vehicle management server, and displaying the obtained diagnostic information on a display, thereby allowing a technician to view the obtained diagnostic information.

As described herein, DSRC apparatuses, vehicle management servers, DSRC wireless interfaces, vehicle bus interfaces, GPS receivers, displays, user interfaces, etc. may be configured using any suitable hardware and/or software configurations. For example, the devices may include a microcontroller, microprocessor, digital signal processor, etc. having computer-executable instructions adapted to cause the device to perform the described operations when executed by the processors, controllers, etc. The devices may include suitable circuitry, logic gates, etc. to perform the described operations. The devices may include memory (e.g., flash memory, etc.) for storing computer-executable instructions, data, etc.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “includes,” “including,” “has,” “have,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A dedicated short-range communications (DSRC) apparatus for a vehicle, the apparatus comprising:
a receiver configured to determine a location of the vehicle;
a vehicle bus interface coupled to a vehicle bus of the vehicle to obtain diagnostics of the vehicle; and
a DSRC wireless interface configured to communicate wirelessly with a vehicle management server;
wherein the DSRC wireless interface is configured to obtain vehicle information from the receiver and/or the vehicle bus interface and transmit the obtained vehicle information to the vehicle management server.

2. The apparatus of claim 1, wherein the vehicle management server is a vehicle management server of a vehicle dealership and/or a vehicle service center.

3. The apparatus of claim 1, wherein the DSRC wireless interface is configured to communicate wirelessly at a frequency of about 5.9 Gigahertz (GHz) and/or via the IEEE 802.11p wireless communication protocol, and/or wherein the receiver is a global positioning system (GPS) receiver.

4. The apparatus of claim 3, wherein the vehicle information transmitted from the DSRC wireless interface to the vehicle management server includes a location of the vehicle, thereby allowing the vehicle management server to store a location of the vehicle.

5. The apparatus of claim 3, wherein the vehicle information transmitted from the DSRC wireless interface to the vehicle management server includes at least one of a fuel level of the vehicle and a battery charge status of the vehicle, thereby allowing the vehicle management server to store diagnostics of the vehicle.

6. The apparatus of claim 3, wherein the DSRC wireless interface is configured to transmit a DSRC media access control (MAC) address of the DSRC apparatus to the vehicle management server, thereby allowing the vehicle management server to identify the vehicle based on the received MAC address from the DSRC wireless interface.

7. The apparatus of claim 1, wherein the vehicle bus interface is adapted to connect to an on-board diagnostics (OBD) port of the vehicle and/or a controller area network (CAN) bus of the vehicle.

8. The apparatus of claim 7, wherein the DSRC wireless interface is configured to:
obtain firmware information from an electronic control unit (ECU) of the vehicle via the vehicle bus interface; and
transmit the obtained firmware information to the vehicle management server, thereby allowing the vehicle management server to determine whether a firmware update is needed for the ECU of the vehicle.

9. The apparatus of claim 8, wherein the DSRC wireless interface is configured to:
receive firmware upgrade data from the vehicle management server; and
transmit the firmware upgrade data to the ECU of the vehicle via the vehicle bus interface, thereby allowing the ECU of the vehicle to upgrade its firmware.

10. The apparatus of claim 1, wherein the DSRC wireless interface is configured to receive DSRC firmware upgrade data from the vehicle management server, thereby allowing the DSRC apparatus to upgrade its firmware.

11. The apparatus of claim 1, wherein the DSRC apparatus is one of an original equipment manufacturer (OEM) apparatus integrated in the vehicle and an aftermarket apparatus coupled to the vehicle after manufacture of the vehicle.

12. A vehicle management system comprising:
multiple dedicated short-rage communication (DSRC) apparatuses, each DSRC apparatus coupled to a different vehicle and having a receiver for determining a location of the vehicle, a vehicle bus interface coupled to a vehicle bus of the vehicle to obtain diagnostics of the vehicle, and a DSRC wireless interface configured to wirelessly transmit vehicle information; and
a vehicle management server having a DSRC wireless interface configured to receive vehicle information from the multiple DSRC apparatuses.

13. The system of claim 12, wherein the vehicle management server is configured to:
receive a DSRC media access control (MAC) address from each of the multiple DSRC apparatuses; and
synchronize each received DSRC MAC address with a vehicle identification number (VIN) of the vehicle associated with the DSRC MAC address to determine which vehicle corresponds to each DSRC MAC address.

14. The system of claim 12, wherein the transmitted vehicle information includes a location of the vehicle, and the vehicle management server is configured to store the received location of each vehicle in a database.

15. The system of claim 12, wherein the transmitted vehicle information includes at a fuel level of the vehicle and/or a battery charge status of the vehicle, and the vehicle management server is configured to generate an alert when the received fuel level and/or battery charge status is below a threshold.

16. The system of claim 12, wherein each DSRC wireless interface is configured to obtain firmware information from an electronic control unit (ECU) of the vehicle via the vehicle bus interface and to transmit the firmware information to the vehicle management server, and the vehicle management server is configured to:
determine whether a firmware update is needed based on the firmware information received from the DSRC apparatus; and
when a firmware update need is determined, to transmit firmware update information to the DSRC apparatus, thereby allowing the DSRC apparatus to update the firmware of the ECU of the vehicle.

17. The system of claim 12, wherein the vehicle management server is configured to:
detect an approaching vehicle having one of the multiple DSRC apparatuses;
transmit a request for vehicle diagnostic information from the DSRC apparatus;
obtain diagnostic information of the vehicle via wireless transmission from the DSRC wireless interface of the vehicle management server; and
display the obtained diagnostic information on a display, thereby allowing a technician to view the obtained diagnostic information.

18. A method of managing a vehicle using a dedicated short-range communications (DSRC) apparatus, the DSRC apparatus coupled to the vehicle and having a receiver for determining a location of the vehicle, a vehicle bus interface coupled to a vehicle bus of the vehicle to obtain diagnostics of the vehicle, and a DSRC wireless interface configured to wirelessly transmit vehicle information to a vehicle management server, the method comprising:
obtaining vehicle information via the receiver and/or the vehicle bus interface; and
transmitting the obtained vehicle information to the vehicle management server via the DSRC wireless interface.

19. The method of claim 18, further comprising:
transmitting firmware update data from the vehicle management server to the DSRC wireless interface; and
providing the firmware update data to an electronic control unit (ECU) of the vehicle via the vehicle bus interface, thereby allowing the ECU to upgrade its firmware.

20. The method of claim 18, further comprising:
detecting an approach of the vehicle having the DSRC apparatus;
transmitting a request for vehicle diagnostic information from the vehicle management server to the DSRC wireless interface;
transmitting diagnostic information of the vehicle from the DSRC wireless interface to the vehicle management server; and
displaying the obtained diagnostic information on a display, thereby allowing a technician to view the obtained diagnostic information
